(19) United States
(12) Patent Application Publication
(10) Pub. No.: US 2006/0096062 A1
(43) Pub. Date: May 11, 2006

(54) Adjustable hinge assembly

(76) Inventor: Timothy Richard Martin Woolcock, OXFORDSHIRE (GB)

Correspondence Address: Artz & Artz, Suite 250, 28333 Telegraph Road,, Southfield, MI, 48034, US

(21) Appl. No.: 10/536,661

(22) PCT Filed: Nov. 27, 2003
(86) PCT No.: PCT/GB03/05218

§ 371 Date: May 27, 2005

(30) Foreign Application Priority Data
Nov. 30, 2002 (GB) 0228028.7

(51) Int. Cl. E05D 7/04

(52) U.S. Cl. 16/238

(57) ABSTRACT

A hinge assembly 15 for a vehicle tailgate 14 comprises a first hinge member 21 fastened to the tailgate 14 and a second hinge member 22 fastened to a hollow flange 23 of a vehicle roof 13 by means of adjustment device 24 comprising an adjustment nut 25 and a locking screw 26. The second hinge member 22 has a hollow cylindrical shank portion 35 with a left-hand external screw thread 36 and a right-hand internal thread 38. Further, the adjustment nut 25 having a screw thread 39 engaged with the external thread 36 of the hollow shank portion 35 and the locking screw 26 having a screw thread 41 engaged with the internal thread 38 of the hollow shank portion 35.

This invention relates to adjustable hinge assemblies and particularly but not exclusively to adjustable hinge assemblies for pivotally securing a tailgate, door or other closure or of a vehicle to part of the vehicle body structure.

Typically, the doors or tailgate of a vehicle, particularly a motor vehicle, are pivotally connected to the body structure by means of two or more hinges. Usually these hinges have one plane of adjustment between the hinge and the body structure and one plane of adjustment between the hinge and the door or closure. Because the hinge is normally attached to the closure first and then to the body structure, there is only one plane of adjustment unless the fixings which have already been tightened are released and then re-tightened. This release and re-tightening process often introduces errors in the positioning of the closure and is also time consuming and disruptive in a production line environment.

EP-A-1094184 shows a hinge assembly which attempts to overcome the above problems. The hinge assembly includes an adjustment device comprising an adjustment nut having a clamp face which faces one side of a flange on the vehicle body structure and a locking screw having a head which can clamp onto the other side of the flange and a shank which extends through the flange and engages an internal screw thread in the nut. The nut also has an external screw thread which engages an internal thread in a hinge member and this provides an adjustment in the axial direction of the nut. However, when the screw is tightened to clamp the nut to the flange, the hinge member remains loose on its threads on the nut. While the hinge member cannot rotate, this looseness can, over a period of time, cause fretting corrosion and other problems which would not arise if all components were firmly clamped.

It is an object of this invention to provide an improved hinge assembly where the above problems are prevented or alleviated.

According to a first aspect of the invention there is provided a hinge assembly for pivotally connecting a closure member to a support structure, the hinge assembly comprising a first hinge member for fastening to one of the closure member and the support structure, a second hinge member for fastening to a flange on the other of the support structure and the closure member, pivot means pivotally connecting the first hinge member to the second hinge member and an adjustment device carried by the second hinge member to connect the second hinge member to the flange in a manner which allows adjustment of the position of the second hinge member with respect to the flange, the adjustment device comprising an adjustment nut having a first clamp face which in use faces one side of the flange and a locking screw having a head defining a second clamp face which in use faces the other side of the flange and a shank which in use extends through an aperture in the flange, characterised in that the second hinge member comprises a cylindrical shank portion with a concentric bore and having internal and external screw threads, that the adjustment nut has a screw thread engaged with the external screw thread of the cylindrical shank portion and that the locking screw has a screw thread engaged with the internal screw thread of the cylindrical shank portion.

Preferably the external screw thread of the cylindrical shank portion and the screw thread of the adjustment nut are of the opposite hand to the internal screw thread of the cylindrical shank portion and the screw thread of the locking screw, in which case the external screw thread of the cylindrical shank portion and the screw thread of the adjustment nut are conveniently left-hand and the internal screw thread of the cylindrical shank portion and the screw thread of the locking screw are right-hand.

The hinge assembly may further comprise friction means on one of the locking screw and the adjustment nut for providing a driving torque between the locking screw and the adjustment nut.

The adjustment nut may be provided with a drive means used to facilitate rotation of the adjustment nut during adjustment of the hinge assembly. The drive means may be in a bore of the adjustment nut and preferably is a hexagonal shaped portion of the bore.

The invention also provides, according to a second aspect thereof, a motor vehicle having a body structure and a closure member, the closure member being connected to the body structure by a hinge assembly in accordance with said first aspect of the invention. In such a case, the flange on the said other of the support structure and the closure member conveniently comprises two spaced apart flange members defining a cavity therebetween, the adjustment nut being positioned so as to react against one of the flange members and the locking screw being arranged so as to react against the other of the two flange members. A tubular spacer may be positioned in the cavity between the flange members to react a clamping force applied to the flange members by the locking screw and the adjustment nut.

The invention also provides, according to a third aspect thereof a method of attaching a closure member to a body structure of a motor vehicle in accordance with said second aspect of the invention, the method comprising the steps of supplying the first hinge member, the second hinge member and the adjustment nut with the first hinge member and the second hinge member pivotally connected by the pivot means and the adjustment nut threaded onto the cylindrical shank portion, aligning the cylindrical shank portion with the aperture in the flange to conform to the required position of the closure member relative to the body structure, rotating the adjustment nut on the cylindrical shank portion to conform to said required position and inserting the locking screw through the aperture in the flange to engage the adjustment nut and rotating the locking screw to clamp the hinge assembly to the flange.

Preferably, the closure member is positioned and held in said required position prior to rotating the adjustment nut on the cylindrical shank portion to conform to said required position, the adjustment nut then being rotated to bring the first clamp face into supporting contact with the flange. The closure member may be held in the required position by an assembly fixture to which it is releasably attached.

Preferably, the adjustment nut is rotated until a pre-determined tightening torque is reached. Conveniently, when the hinge assembly comprises friction means on one of the locking screw and the adjustment nut for providing a driving torque between the locking screw and the adjustment nut, the adjustment nut is rotated by said friction means during the rotation of the locking screw.

The invention will now be described by way of example with reference to the accompanying drawings, of which:

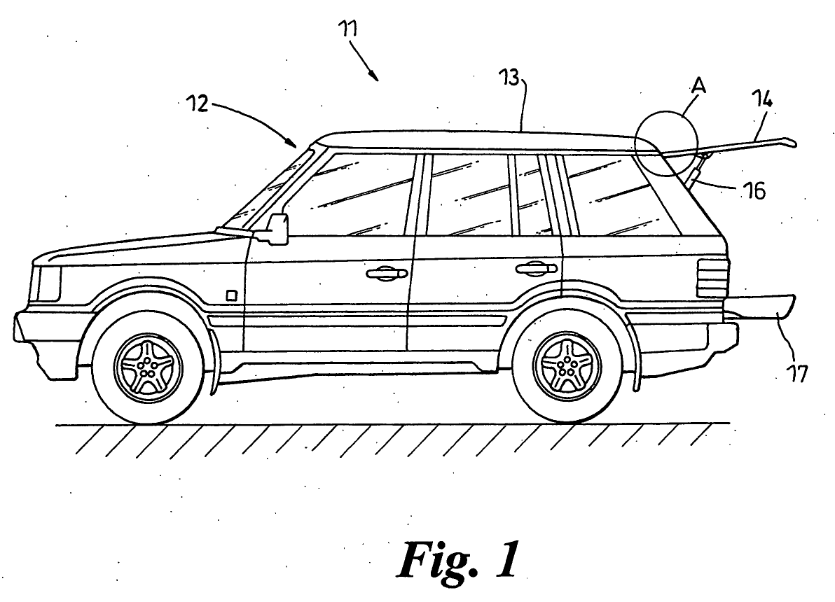

FIG. 1 is a side elevation of a motor vehicle incorporating a hinge assembly according to the invention;

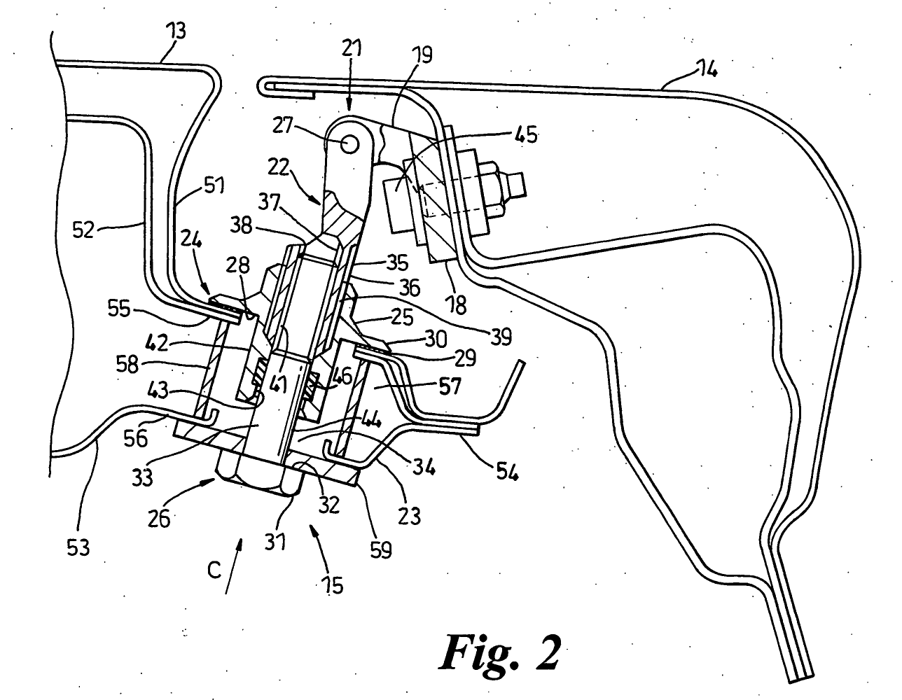

FIG. 2 is a cross-section through part of the motor vehicle shown in FIG. 1 in the region encircled at A and showing the hinge assembly;

FIG. 3 is a perspective view of part of the hinge assembly shown in FIG. 1:

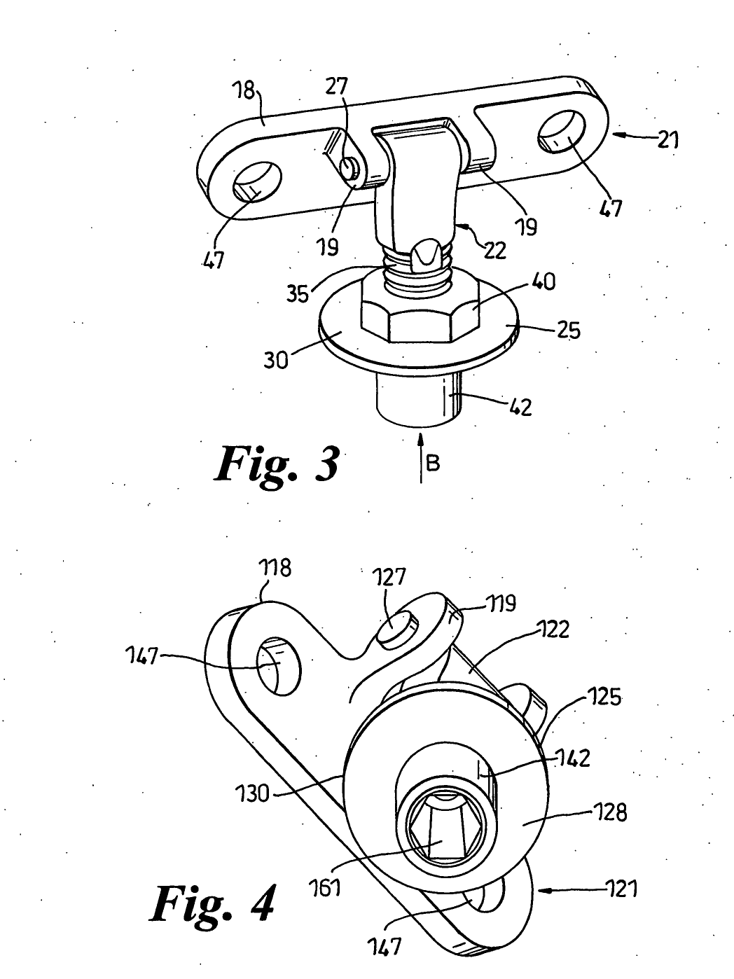

FIG. 4 is a perspective view in the direction of arrow B in FIG. 2 showing a modification;

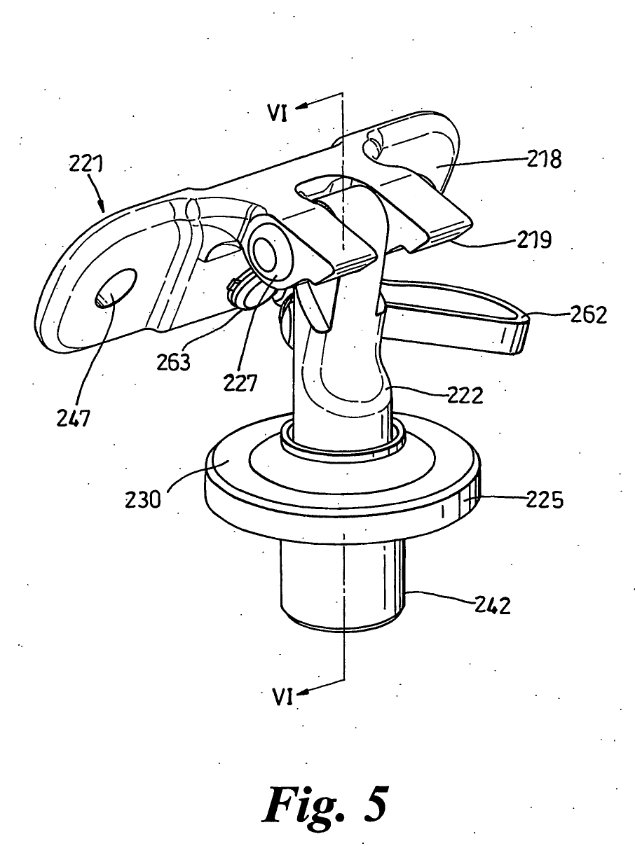

FIG. 5 is a perspective view similar to that of FIG. 3 showing a further modification; and

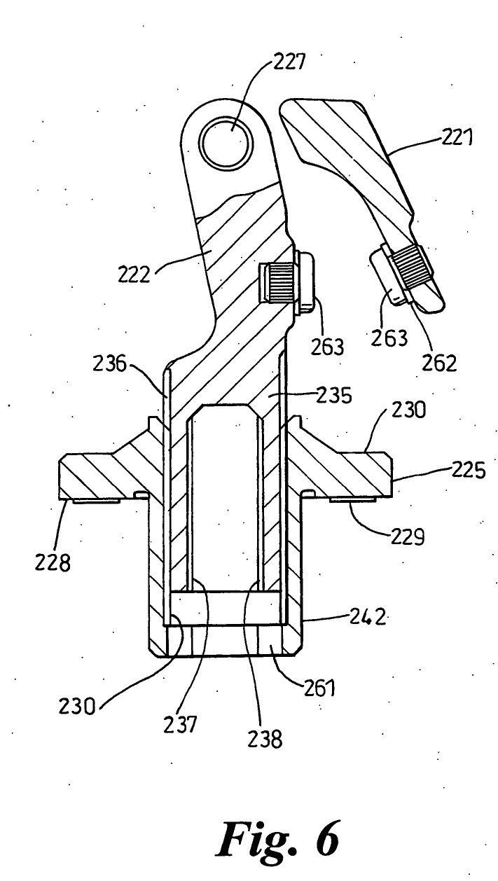

FIG. 6 is a cross-section on the line VI-VI in FIG. 5.

Referring to FIGS. 1 to 3, a motor vehicle 11 has a body structure 12 including a roof 13 to which is hinged an upper tailgate 14 by means of a pair of adjustable hinge assemblies 15. The upper tailgate 14 is supported in the open position by a pair of gas struts 16. A lower tailgate 17 is also provided. Such tailgates 14, 17 and other doors of the vehicle are usually referred to as closure members or simply closures.

Each hinge assembly 15 comprises a first hinge member 21 pivotally connected to a second hinge member 22 fastened to a hollow flange 23 by means of adjustment device 24 comprising an adjustment nut 25 and a locking screw 26; The hollow flange 23 forms part of the roof 13 which thus acts as a support structure for the hinge assembly 15. The first hinge member 21 has a base flange 18 by which it is fastened to the upper tailgate 14 and two lugs 19 which extend either side of the second hinge member 22 to support pivot means in the form of a pivot pin 27 which extends through the lugs 19 and the second hinge member 22. The adjustment nut 25 has a flange 30 with a lower face 28 which defines a first clamp face facing the upper side of the flange 23 and which carries a sealing gasket 29. The locking screw 26 has a hexagonal head 31, the underside of which defines a second clamp face 32 which faces the lower side of the flange 23, and a solid shank 33 which extends through an aperture 34 in the hollow flange 23.

The second hinge member 22 has a hollow cylindrical shank portion 35 having an external screw thread 36 and a concentric bore 37 having an internal screw thread 38, the adjustment nut 25 having a screw thread 39 engaged with the external screw thread 36 of the hollow shank portion 35. Similarly, the locking screw 26 has a screw thread 41 engaged with the internal screw thread 38 of the hollow shank portion 35.

The adjustment nut 25 has a hexagon 40 above the flange 30 to act as a drive means for holding or rotating the nut during assembly and adjustment and a tubular spigot 42 which projects below the lower face 28 of the flange 30. The tubular spigot 42 has a plain bore 43 which surrounds a plain shank portion 44 of the locking screw 26. A recess in the bore 43 of the adjustment nut 25 carries a ring 46 (conveniently referred to as a friction ring) of a resilient plastics material which acts as a friction means for providing a driving torque between the locking screw 26 and the adjustment nut 25.

The hollow flange 34 is formed by three pressings, i.e. an upper pressing 51 which forms the outer skin of the roof 13, an intermediate pressing 52 which forms the inner skin of the roof 13 and which is in close contact with the upper pressing 51 in the region of the hollow flange 34 and a lower pressing 53 which forms part of a tailgate opening in the body structure 12. The upper pressing 51, intermediate pressing 52 and lower pressing 53 are joined at an outer flange 54. The upper pressing 51 and the intermediate pressing 52 thus form an upper flange member 55 which is spaced apart from a lower flange member 56 formed by the lower pressing 53 to define a cavity 57 therebetween, the adjustment nut 25 being positioned to react against the upper flange member 55 and the locking screw 26 being arranged so as to react against the lower flange member 56. A tubular spacer 58 is positioned in the cavity 57 between the flange members 55, 56 to react a clamping force applied to the flange members by the locking screw 26 and the adjustment nut 25, the clamping force from the locking screw 26 being applied through a washer 59 sandwiched between the head 31 and the lower flange member 56.

The external thread 36 on the hollow shank portion 35 of the second hinge member 22 is of the opposite hand to the internal thread 38 for reasons which will be explained later. In this particular example, the external thread 36 and the corresponding thread 39 in the adjustment nut 25 are left-handed while the internal thread 38 and the corresponding thread 41 on the locking screw 26 are right-handed. This allows the use of a commercially available standard fastener for the locking screw 26.

Setting of the hinge assembly 15 is as follows. The first and second hinge members 21 and 22 are provided as a sub-assembly complete with the pivot pin 27 and with the adjustment nut 25 threaded as far as it will go onto the shank portion 35 of the second hinge member 22, this being the condition shown in FIG. 2. The first hinge member 21 is then fastened to the tailgate 14 using cap screw fasteners 45 inserted through holes 47 in the base flange 18. The tailgate 14 is then moved into a required position corresponding to the correct position of the tailgate relative to the body structure 12 using an assembly fixture (not shown) to which the tailgate is releasably secured. The assembly fixture would typically be carried by a robot to grasp the tailgate 14 and hold it in the desired position corresponding to the normal closed position of the tailgate. Normally, during the assembly of the vehicle, this would be done before painting and before any seals have been put onto the tailgate 14 or onto the body structure. Also, the windows of the vehicle would not be glazed at this stage so there would be ready access to the inside of the vehicle for robot arms or human operators to insert and tighten the locking screws 26.

The spigot 42 of the adjustment nut 25 is positioned in the clearance aperture 34 at the time that the tailgate 14 is being brought into its correct position, the spacer 58 having already been placed in position during fabrication of the body structure 12. The tailgate 14 having been positioned correctly, the hinge assembly 15 is adjusted to ensure that the tailgate 14 will be in the correct position relative to the body structure 12 when the assembly fixture is released. This is done by inserting the locking screw 26, with the washer 59 in place, into the bore 43 of the adjustment nut 25 until the thread 41 engages the friction ring 46. The thread 41 winds into the friction ring 46 with a self-tapping action until the friction grip between the locking screw 26 and the adjustment nut 25 provides sufficient torque for the locking screw 26 to rotate the adjustment nut 25 in the clockwise direction (as viewed in the direction of arrow C in FIG. 2). This causes the adjustment nut 25 to move along the shank portion 35 of the second hinge member 22 in the direction away from the pivot pin 22 until the lower face 28 (or rather the gasket 30) engages the upper flange member 55. The locking screw 26 will then continue to rotate without further rotation of the adjustment nut 25 so that the thread 41 winds through the friction ring 46 and engages the internal thread 38 of the adjustment nut 25, thus bringing the washer 59 up to the lower flange member 56 and clamping the hinge assembly 15 to the flange 23. After the locking screw 26 has been tightened to the required torque, the tailgate 14 is released from the assembly fixture to allow it to rotate normally with respect to the body structure 12.

The clearance between the spigot 42 of the adjustment nut 25 and the aperture 34 in the hollow flange 34 is normally sufficient to allow the assembly fixture to move the tailgate 14 into the correct longitudinal and lateral positions when the spigot 42 is located in the aperture 34. If minor adjustments are required to the hinge assembly 15 during the service life of the vehicle 11 then the hexagon 40 on the adjustment nut 25 can be used to rotate the adjustment nut 25.

By providing the first and second hinge members 21 as a sub-assembly with the adjustment nut 25 threaded as far as it will go onto the cylindrical shank portion 35 of the second hinge member 22, the threads 36 and 38 are protected during transport and handling. Furthermore, because the locking screw 26 acts directly on the second hinge member 24, it not only acts to tighten its own thread 41 with the internal thread 38 of the second hinge member 22 but also acts to tighten the external thread 36 of the second hinge member 22 with the thread 39 of the adjustment nut.24 so that all the components of the adjustment device 24 are firmly clamped.

Other friction means may be employed instead of the friction ring 46. For example, the shank 33 of the locking screw 26 may be coated with a plastics material or may be sleeved by a tube of such material, e.g. by heat shrinking. This would enable the use of a plain bore in the adjustment nut 25 without the recess for the friction ring 46. A metal collar incorporating a spring grip device could also be used. Such a collars are sometimes used in self-adjusting spacing collar devices of the kind shown in U.S. Pat. No. 4,682,906.

In the modification shown in FIG. 4 similar or identical parts carry the same part number as those in FIGS. 1 to 3 with the addition of 100. The adjustment nut 125 differs in that the there is no friction ring 46 but the bore of the spigot 142 has a drive means in the form of a hexagonal shaped socket portion 161 to facilitate rotation of the adjustment nut 130. This means that instead of using the locking screw 26 to bring the adjustment nut to the required position a hexagonal shaped driver is inserted into the hexagonal shaped socket portion 161 to rotate the adjustment nut 125 until the gasket 29 engages the upper flange member 55 and a pre-determined torque has been reached. The hexagonal shaped driver is then removed and the locking screw 26 is inserted into the adjustment nut 125 and tightened as before. Other drive means, e.g. splines, could be provided instead of the hexagonal drive means. In this modification, the use of left and right-hand threads is not essential but it remains a useful feature if there should be any friction between the locking screw 26 and the adjustment nut 130 which might otherwise induce the adjustment nut to unwind when the locking screw is inserted and tightened. It will be appreciated that the setting of the adjustment nut 125 by the hexagonal shaped driver can be carried out with the tailgate 14 closed.

In the further modification shown in FIGS. 5 and 6 similar or identical parts carry the same part number as those in FIGS. 1 to 3 with the addition of 200. The adjustment nut 225 again differs in that the there is no friction ring 46 and the bore of the spigot 242 again has a drive means in the form of a hexagonal shaped socket portion 261 to facilitate rotation of the adjustment nut 30. There is no hexagon corresponding to the hexagon 40 above the flange 230 since this is not required for assembly purposes and similar techniques can be adopted during service or repair. An earthing strap 262 is provided to ensure a good electrical connection between the hinge portions 221 and 222 and this is secured by serrated drive rivets 263.

Although the invention has been described with specific reference to a top hinged tailgate it will be appreciated that it is equally applicable to the fixing of doors and other closures on both motor vehicle and other structures requiring accurate setting of the closure relative to the support structure. Furthermore, the second hinge member could be fastened to either the support structure or the closure member depending upon the situation with a corresponding fastening of the first hinge member to the closure member or to the support structure. It will also be appreciated that the invention is equally applicable to combination or multi-link (e.g. pantograph) hinges having several hinge members interposed between the closure member and its support structure.

What is claimed is:

1-22. (canceled)

23. A hinge assembly for pivotally connecting a closure member to a support structure, the hinge assembly comprising:
a first hinge member for fastening to one of the closure member and the support structure;
a second hinge member for fastening to a flange on the other of the support structure and the closure member;
a pivot means pivotally connecting the first hinge member to the second hinge member; and
an adjustment device carried by the second hinge member to connect the second hinge member to the flange;
the adjustment device for adjusting the position of the second hinge member with respect to the flange;
the adjustment device comprising an adjustment nut and a locking screw;
the adjustment nut having a first clamp face which in use faces one side of the flange;
the locking screw having a head and a shank;
the head defining a second clamp face which in use faces the other side of the flange;
the shank which in use extends through an aperture in the flange;
the second hinge member comprising a cylindrical shank portion with a concentric bore and having internal and external screw threads;
the adjustment nut having an adjustment screw thread engaged with the external screw thread of the cylindrical shank portion;
the locking screw having a locking screw thread engaged with the internal screw thread of the cylindrical shank portion.

24. A hinge assembly as claimed in claim 23 wherein the adjustment device includes a spigot which in use engages the aperture in the flange with a substantial clearance.

25. A hinge assembly as claimed in claim 24 wherein the spigot extends from the adjustment nut.

26. A hinge assembly as claimed in claim 23 wherein a sealing gasket is interposed between the adjustment nut and said one side of the flange.

27. A hinge assembly as claimed in claim 23 wherein a washer is interposed between the head of the locking screw and said other side of the flange.

28. A hinge assembly as claimed in claim 23 wherein the external screw thread of the cylindrical shank portion and the adjustment screw thread of the adjustment nut are of the opposite hand to the internal screw thread of the cylindrical shank portion and the locking screw thread of the locking screw.

29. A hinge assembly as claimed in claim 28 wherein the external screw thread of the cylindrical shank portion and the adjustment screw thread of the adjustment nut are left-hand and the internal screw thread of the cylindrical shank portion and the locking screw thread of the locking screw are right-hand.

30. A hinge assembly as claimed in claim 23 and further comprising a friction means on one of the locking screw and the adjustment nut for providing a driving torque between the locking screw and the adjustment nut.

31. A hinge assembly as claimed in claim 23 further comprising a drive means used to facilitate rotation of the adjustment nut during adjustment of the hinge assembly.

32. A hinge assembly as claimed in claim 31 wherein the adjustment nut has a bore with the drive means formed therein.

33. A hinge assembly as claimed in claim 32 wherein the drive means is a hexagonal shaped portion of the bore of the adjustment nut.

34. A motor vehicle comprising:
a body structure;
a closure member; and
a hinge assembly connecting the closure member to the body structure;
the hinge assembly comprising a first hinge member, a second hinge member, a pivot means pivotally connecting the first hinge member to the second hinge member, and an adjustment device carried by the second hinge member;
the first hinge member for fastening to one of the closure member and the support structure;
the second hinge member for fastening to a flange on the other of the support structure and the closure member;
the adjustment device for adjusting the position of the second hinge member with respect to the flange;
the adjustment device comprising an adjustment nut and a locking screw;
the adjustment nut having a first clamp face which in use faces one side of the flange;
the locking screw having a head and a shank;
the head defining a second clamp face which in use faces the other side of the flange;
the shank which in use extends through an aperture in the flange;
the second hinge member comprising a cylindrical shank portion with a concentric bore and having internal and external screw threads;
the adjustment nut having an adjustment screw thread engaged with the external screw thread of the cylindrical shank portion;
the locking screw having a locking screw thread engaged with the internal screw thread of the cylindrical shank portion.

35. A motor vehicle as claimed in claim 34 wherein the flange comprises two spaced apart flange members defining a cavity therebetween, the adjustment nut being positioned so as to react against one of the flange members and the locking screw being arranged so as to react against the other of the flange members.

36. A motor vehicle as claimed in claim 35 wherein a tubular spacer is positioned in the cavity between the flange members to react a clamping force applied to the flange members by the locking screw and adjustment nut.

37. A motor vehicle as claimed in claim 34 further comprising:
a friction means coupled to one of the locking screw and the adjustment nut for providing a driving torque between the locking screw and the adjustment nut.
